(19) United States
(12) Patent Application Publication
(10) Pub. No.: US 2019/0042775 A1
(43) Pub. Date: Feb. 7, 2019

(54) METHOD FOR OPERATING AN ACCESS CONTROL SYSTEM COMPRISING A SERVER, AT LEAST ONE ACCESS CONTROL DEVICE AND AT LEAST ONE POINT OF SALE DEVICE FOR ACCESS PERMISSIONS FOR THE AREA COVERED BY THE ACCESS CONTROL SYSTEM

(71) Applicant: SKIDATA AG, Salzburg (AT)

(72) Inventors: Alois HARASEK, Seekirchen (AT); Anders MALMBORG, Salzburg (AT); Georg DACHS, Bergheim (AT); Peter FÜRHAPTER, Salzburg (AT)

(21) Appl. No.: 16/039,534

(22) Filed: Jul. 19, 2018

(30) Foreign Application Priority Data
Aug. 7, 2017 (EP) 17185104.1

(51) Int. Cl. G06F 21/62; G06F 21/60; G06Q 20/20

(52) U.S. Cl. CPC G06F 21/62; G06Q 20/20; G06F 21/602

(57) ABSTRACT

A method of operating an access control system comprising a server (3), a control device (4) and a point of sales device (1) for access permissions to a covered area. An algorithm is installed on the point of sales device (1) which can only be executed locally if unlocked by a key transmitted by the server. If a point of sales device is not connected to the server, the algorithm is executed using the key and access permission is generated, encrypted and marked as an offline-generated access permission and encoded. If access control is carried out while the point of sales device is unconnected, the offline-generated access permission is read out by an access control device (4). Based on labelling as an offline-generated access permission, it is identified as such and the validity of the access permission is verified based on the data encoded by the point of sales device.

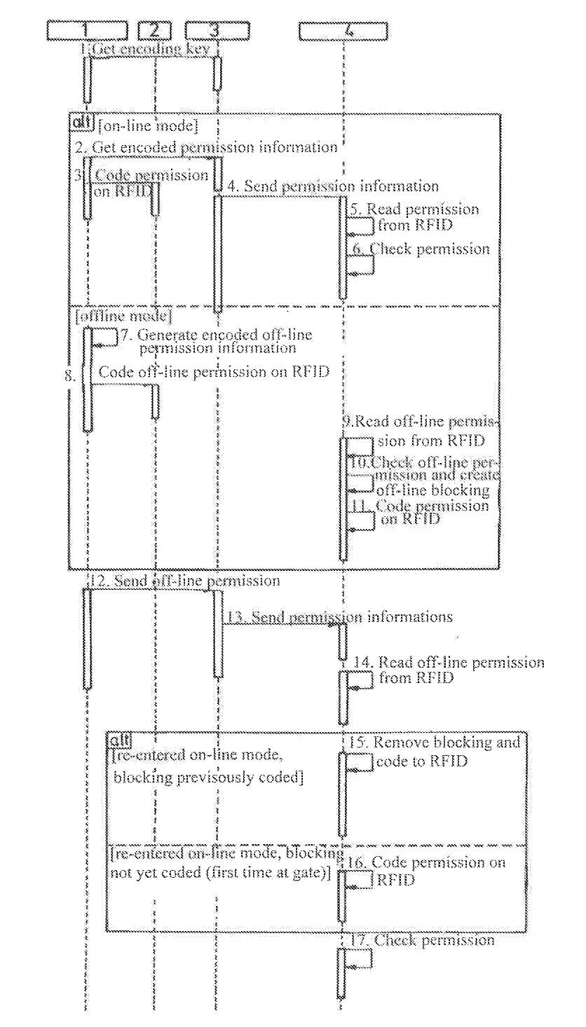

This application claims priority from European patent application serial no. 17185104.1 filed Aug. 7, 2017.

### FIELD OF THE INVENTION

The present invention relates to a method for operating an access control system comprising a server, at least one access control device and at least one point of sale device for access permissions for the area covered by the access control.

### BACKGROUND OF THE INVENTION

From the prior art, access control systems are known which have a server and at least one access control device which is connected to the server for the purpose of data communication. For selling the access permissions for the area covered by the access control system, points of sales are provided, wherein when an access permission is purchased, the access permission is encoded onto a customer medium by means of a point of sales device connected to the server for the purpose of data communication using an encoding device, by means of an RFID standard, preferably the ISO 15693 standard. In this case, the access permission is generated and encrypted in the server.

According to the prior art the algorithms for the generation and encryption of access privileges are stored on the server and are not distributed to the point of sales devices connected to the server for the purpose of communication. The access permissions are generated and encrypted in the server and are encoded onto the customer medium via the point of sales devices connected to the server for the purpose of data communication, wherein after the coding of the access permissions information concerning the validity of the respective access permissions is transmitted from the server to the access control devices.

Disadvantageously, in the event of a network failure, i.e. in an offline mode of the point of sales devices, no access permissions can be sold, since according to the prior art these cannot be generated and encrypted by the sales outlets.

### SUMMARY OF THE INVENTION

The object of the present invention is to specify a method for operating an access control system comprising a server, at least one access control device and at least one point of sales device for access permissions for the area covered by the access control system, by the execution of which for the case when a point of sales device of an access control system is in an offline mode, the operation of the access control system and, in particular, the sale of access permissions, is maintained.

This object is achieved by the features of the Patent Claim. An advantageous extension is the subject matter of the dependent claim.

Consequently, a method is proposed for operating an access control system comprising a server, at least one access control device and at least one point of sales device for access permissions for the area covered by the access control system, in the context of which the algorithm for generating and encrypting the access permissions is installed on the at least one point of sales device, wherein the algorithm can only be executed locally, i.e. in the at least one point of sales device, if it is unlocked using a key.

According to the invention, when powering up or switching on a point of sales device, the key for unlocking the algorithm for generating and encrypting access permissions, which is installed in the point of sales device, is transferred from the server to the point of sales device, wherein in the online case, i.e. when the point of sales device is connected to the server, the point of sales device requests an access permission from the server, which is generated and encrypted in the server and transmitted from the server to the point of sales device, wherein the access permission is encoded on a customer medium using an encoder device of the point of sales device. Subsequently, the information concerning the validity of the coded access permission is transmitted from the server to the at least one access control device, wherein for the purpose of access control the access permission is read out by the respective access control device and the validity of the access permission is verified on the basis of the information transmitted from the server.

In the offline case, i.e. when a point of sale device is not connected to the server, the algorithm installed on the point of sales device is executed using the key for unlocking the algorithm installed on the point of sales device, wherein by means of the algorithm installed on the point of sale device an access permission is generated, encrypted and labelled as an offline-generated access permission, wherein this access permission is then encoded onto a customer medium using the encoding device of the point of sales device.

If an access control is performed while the point of sale device is not connected to the server, the offline-generated access permission is read out by an access control device, wherein on the basis of the labelling as an offline-generated access permission it is recognized as such, wherein the validity of the access permission is verified on the basis of the data encoded by the point of sales device.

If the point of sales device is subsequently in an online mode, which corresponds to the normal operating state, the information concerning the access permissions generated by the point of sales device in the offline mode is transmitted from the point of sales device to the server, which in turn transmits the information concerning the validity of the access permissions to the at least one access control device.

If after the point of sale device has changed into the online mode an access control process takes place with an access permission generated by the point of sale device in the offline mode, the offline-generated access permission is read out of the customer medium by the access control device, wherein an access permission is encoded onto the customer medium based on the information transmitted by the server, and the validity of the access permission is then verified.

As part of an extension of the invention, it is provided that if an access control is performed while the point of sale device is not connected to the server, a time-restricted validity, namely the information that the access permission becomes invalid after a specified time, is encoded onto the customer medium by the access control device, wherein the time-restricted validity is removed if an access control operation takes place after the point of sale device has changed into the online mode.

### BRIEF DESCRIPTION OF THE DRAWING

In the following an embodiment of the invention is described in greater detail on the basis of the attached FIGURE, which shows a sequence diagram to illustrate the features of the method according to the invention.

### DETAILED DESCRIPTION OF THE PREFERRED EMBODIMENTS

According to the invention the algorithm for generating and encrypting the access permissions is installed on the at least one point of sales device of the access control system, wherein the algorithm installed on the at least one point of sales device can only be executed if it is unlocked using a key. Referring to the attached figure, when powering up or switching on a point of sales device 1, the key for unlocking the algorithm installed in the point of sales device 1 for generating and encrypting access permissions is transmitted from the server 3 to the point of sales device 1 (step 1).

If the point of sales device 1 is in the online mode, the point of sales device 1 requests from the server 3 an access permission, which is generated and encrypted in the server 3 and transmitted from the server 3 to the point of sales device (step 2), wherein the access permission is then encoded on a customer medium (step 3) using an encoding device 2 of the point of sales device 1.

Subsequently, the information concerning the validity of the coded access permission is transmitted from the server 3 to the at least one access control device 4 of the access control system (step 4), wherein for the purpose of access control the access permission is read out by the respective access control device (step 5) and the validity of the access permission is verified on the basis of the information transmitted by the server 3.

When a point of sale device is in an offline mode, the algorithm installed on the point of sales device 1 is executed using the key for unlocking the algorithm installed in the point of sales device 1, wherein by means of the algorithm installed on the point of sales device 1 an access permission is generated, encrypted and labelled as an offline-generated access permission (step 7), wherein this access permission is then encoded onto a customer medium by the encoding device of the point of sales device (step 8).

In the event of an access control while the point of sale device 1 is not connected to the server 3, the offline-generated access permission is read out (step 9) by an access control device, wherein on the basis of the labelling as an offline-generated access permission it is recognized as such, the validity of which is verified (step 10) on the basis of the data encoded by the encoding device 2 of the point of sales device 1 and a time-restricted validity restriction, namely the information that the access permission becomes invalid after a specified time, is encoded onto the customer medium (step 11).

If the point of sales device 1 then changes into the online mode, the information concerning the access permissions generated by the point of sales device 1 in the offline mode is transmitted from the point of sales device 1 to the server 3 (step 12), where the server 3 transmits the information about the validity of the access permissions to the at least one access control device 4 of the access control system (step 13).

In the event of a subsequent access control with an access permission generated by the point of sales device 1 in the offline mode, i.e. without a connection to the server 3, the offline-generated access permission is read out by an access control device (step 14), wherein if a time-restricted validity was encoded on the customer medium, which means that the customer medium was verified by an access control device 4 during the offline mode of the point of sales device 1, the time-restricted validity is removed and an access permission is encoded onto the customer medium based on the information transmitted from the server 3 (step 15), wherein the validity of the access permission is then checked.

If the customer medium was not verified during the offline mode of the point of sales device 1, i.e. if no time-restricted validity is encoded on the customer medium, an access permission is encoded on the customer medium (step 16) based on the information transmitted from the server concerning the validity of the access permission, wherein the validity of the access permission is then checked.

1. A method for operating an access control system comprising a server (3), at least one access control device (4) and at least one point of sale device (1) for access permissions for the area covered by the access control system, characterized in that an algorithm for generating and encrypting the access permissions is installed on the at least one point of sale device (1), wherein the algorithm installed on the at least one point of sale device (1) can only be executed locally, i.e. in the at least one point of sale device (1), if it is unlocked using a key, wherein when powering up or switching on a point of sale device (1) the key for unlocking the algorithm for generating and encrypting access permissions installed in the point of sales device (1) is transmitted from the server (3) to the point of sales device (1), wherein if a point of sales device (1) is connected to the server (3), the point of sales device (1) requests from the server (3) an access permission, which is generated and encrypted in the server and transmitted from the server (3) to the point of sales device (1), wherein the access permission is then encoded via an encoding device (2) of the point of sales device (1) onto a customer medium and wherein the information concerning the validity of the encoded access permission is transferred from the server (3) to the at least one access control device (4), wherein for the purpose of access control the access permission is read out by the respective access control device (4) and the validity of the access permission is verified on the basis of the information transmitted from the server (3), wherein if a point of sales device (1) is not connected to the server (3), the algorithm installed on the point of sales device (1) is executed using the key for unlocking the algorithm installed in the point of sale device (1), wherein by means of the algorithm installed on the point of sale device (1) an access permission is generated, encrypted and labelled as an offline-generated access permission, wherein this access permission is then encoded onto a customer medium using the encoding device (2) of the point of sales device (1), wherein if an access control is performed while the point of sales device (1) is not connected to the server (3), the offline-generated access permission is read out by an access control device (4), wherein on the basis of the labelling as an offline-generated access permission it is recognized as such and the validity of the access permission is verified on the basis of the data encoded by the point of sales device (1), wherein if the point of sales device (1) is subsequently connected to the server (3), the information concerning the access permissions generated by the point of sales device (1) in the offline mode is transmitted from the point of sales device (1) to the server (3), which transmits the information concerning the validity of the access permissions to the at least one access control device (4), wherein if, after the point of sale device (1) has changed into the online mode an access control process takes place with an access permission which was generated by the point of sales device (1) in the offline mode, the offline-generated access permission is read out of the customer medium by the access control device (4) and an access permission is encoded onto the customer medium based on the information transmitted by the server (3), and wherein the validity of the access permission is then verified.

2. The method for operating an access control system comprising a server (3), at least one access control device (4) and at least one point of sales device (1) for access permissions for the area covered by the access control system, according to claim 1, further comprising, if an access control is performed while the point of sales device (1) is not connected to the server (3), encoding a time-restricted validity onto the customer medium by the access control device (4), and
removing the time-restricted validity if an access control operation takes place after the point of sales device (1) changes into the online mode.

3. A method of operating an access control system comprising a server, at least one access control device and at least one point of sale device for access permissions for the area covered by the access control system, the method comprising:
installing an algorithm for generating and encrypting the access permissions on the at least one point of sale device and the algorithm installed on the at least one point of sale device can only be executed locally if the algorithm is unlocked using a key,
when powering up or switching on a point of sale device, transmitting the key for unlocking the algorithm, for generating and encrypting access permissions installed in the point of sales device, from the server to the point of sales device, if the point of sales device is connected to the server, the point of sales device requests access permission from the server, which is generated and encrypted in the server and transmitted from the server to the point of sales device,
then encoding the access permission, via an encoding device of the point of sales device, onto a customer medium and transferring the information concerning the validity of the encoded access permission from the server to the at least one access control device,
reading out the access permission, for the purpose of access control, by the respective access control device and verifying validity of the access permission on a basis of the information transmitted from the server,
if a point of sales device is not connected to the server, executing the algorithm installed on the point of sales device using the key for unlocking the algorithm installed in the point of sale device,
generating an access permission, encrypted and labeled as an offline-generated access permission, by the algorithm installed on the point of sale device,
then encoding this access permission onto a customer medium using the encoding device of the point of sales device,
if an access control is performed while the point of sales device is not connected to the server, reading out the offline-generated access permission by an access control device,
on the basis of the labeling as an offline-generated access permission, recognizing and verifying the validity of the access permission on a basis of the data encoded by the point of sales device,
if the point of sales device is subsequently connected to the server, transmitting the information concerning the access permissions generated by the point of sales device, in the offline mode, from the point of sales device to the server, and transmitting the information concerning the validity of the access permissions to the at least one access control device,
if, after the point of sale device changes into the online mode, an access control process takes place with an access permission which was generated by the point of sales device in the offline mode, reading out of the customer medium the offline-generated access permission by the access control device and encoding an access permission onto the customer medium based on the information transmitted by the server, and
verifying the validity of the access permission.

4. The method of operating an access control system comprising a server, at least one access control device and at least one point of sales device for access permissions for the area covered by the access control system according to claim 3, further comprising, if an access control is performed while the point of sales device is not connected to the server, encoding a time-restricted validity onto the customer medium by the access control device, and
removing the time-restricted validity if an access control operation takes place after the point of sales device changes into the online mode.
